(19) United States
(12) Patent Application Publication
(10) Pub. No.: US 2026/0168656 A1
(43) Pub. Date: Jun. 18, 2026

(54) DOWNSIZER RING ADAPTER FOR SPACKLE FRAME AND FOR LARGER CEILING HOLE

(71) Applicant: AMP Plus, Inc., Vernon, CA (US)

(72) Inventor: Brandon Cohen, Vernon, CA (US)

(73) Assignee: AMP Plus, Inc., Vernon, CA (US)

(21) Appl. No.: 19/412,241

(22) Filed: Dec. 8, 2025

Related U.S. Application Data
(63) Continuation-in-part of application No. 19/057,375, filed on Feb. 19, 2025.
(63) Continuation-in-part of application No. 19/020,672, filed on Jan. 14, 2025.
(63) Continuation-in-part of application No. 29/894,010, filed on Jun. 5, 2023, now Pat. No. D1108685.
(63) Continuation-in-part of application No. 29/962,228, filed on Sep. 10, 2024, now Pat. No. D1108686.
(63) Continuation-in-part of application No. 29/981,337, filed on Dec. 30, 2024, now Pat. No. D1108687.
(63) Continuation-in-part of application No. 18/597,114, filed on Mar. 6, 2024.

(51) Int. Cl. F21V 21/04

(52) U.S. Cl. CPC F21V 21/049

(57) ABSTRACT

With respect to ceiling recessed lighting applications that desire a flangeless trim finish, the present invention is an adapter, a downsizer-ring, that is used to bridge (span) a gap in a ceiling-hole when that ceiling-hole is too large to use a spackle-frame because the outside-diameter of that spackle-frame is less than a diameter of that ceiling-hole. The adapter is configured to: (1) attach to the ceiling centered around the ceiling-hole; and (2) attach to the spackle-frame. The spackle-frame, attached to the adapter, may then be used normally, receiving a flangeless-trim and a light-source into the flangeless-trim. Bottom surfaces of the adapter, with attached spackle-frame, may be plastered over. The adapter includes two main structures, a main-disc and a raised-platform extending from and above the main-disc. A bottom of the main-disc includes an interior-volume that fits at least a portion of the spackle-frame within.

### PRIORITY NOTICE

The present application, a continuation-in-part (CIP) application, claims priority under 35 U.S.C. § 120 to U.S. Non-Provisional patent application Ser. No. 19/057,375 filed on Feb. 19, 2025, the disclosure of which is incorporated herein by reference in its entirety.

The present application, a continuation-in-part (CIP) application, claims priority under 35 U.S.C. § 120 to U.S. Non-Provisional patent application Ser. No. 19/020,672 filed on Jan. 14, 2025, the disclosure of which is incorporated herein by reference in its entirety.

The present application, a continuation-in-part (CIP) application, claims priority under 35 U.S.C. § 120 to U.S. Non-Provisional patent application Ser. No. 18/597,114 filed on Mar. 6, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/894,010 filed on Jun. 5, 2023, the disclosure of which is incorporated herein by reference in its entirety.

The present application, a continuation-in-part (CIP) application, claims priority under 35 U.S.C. § 120 to U.S. Non-Provisional patent application Ser. No. 29/962,228 filed on Sep. 10, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/981,337 filed on Dec. 30, 2024, the disclosure of which is incorporated herein by reference in its entirety.

### CROSS REFERENCE TO RELATED PATENTS

The disclosures and teachings of the following U.S. patents, by the same inventor as the present patent application, are all incorporated by reference as if fully set forth herein: D935082; U.S. Pat. Nos. 10,914,465; 11,092,326; 11,300,259; 11,466,849; 11,668,458; 11,662,084; 11,649,954; and 12,066,175.

### TECHNICAL FIELD OF THE INVENTION

The present invention relates in general to devices used in recessed lighting applications in ceilings and more specifically to an adapter for use with a spackle-frame and a flangeless trim when a hole in a ceiling is too large for using the spackle-frame.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Circa 2025, with respect to recessed lighting applications in ceilings, and with further respect to when a desired architectural finish for a given installed recessed light may be an above ceiling mounted recessed light fixture with a flangeless trim finish, during the installation an installer may cut a hole into the given ceiling that is intended to receive the light fixture and flangeless trim therein (note, a flangeless trim is disclosed and taught in U.S. Pat. No. 11,662,084; see e.g., reference numeral “321” in U.S. Pat. No. 11,662,084 for a flangeless trim); however, sometimes that hole cut into that ceiling may be too large (e.g., have a too-large diameter) to accommodate a given spackle-frame (note, a spackle-frame is disclosed and taught in U.S. Pat. No. 11,662,084; see e.g., reference numeral “201” in U.S. utility U.S. Pat. No. 11,662,084 for a spackle-frame); i.e., a largest outside diameter of the given spackle-frame may be too small to cover over edges of the hole cut into that ceiling; i.e., the spackle-frame may undesirably fit into the that hole cut into that ceiling. If the spackle-frame cannot cover over edge of the hole cut into the ceiling, then the spackle-frame cannot be attached to the ceiling (at least not as intended); and if the spackle-frame cannot be attached to ceiling (and centered) to the hole in the ceiling, then the flangeless trim cannot be attached to the spackle-frame; and then the light-fixture cannot be attached to the flangeless trim. Thus, the entire recess lighting installation, with a flangeless finish, may fail if the hole cut into the ceiling is too large for a given size of spackle-frame.

There is a need in the art for an adapter device (a downsizer-ring or downsizer-adapter) that may be sufficiently large to cover over edges of the hole cut into the ceiling and be attached to the ceiling and centered to the hole in the ceiling; and wherein this adapter device may also be configured to receive and be attached to what would have been a too small spackle-frame, such that a flangeless trim may then be attached to the spackle-frame (wherein the spackle-frame is attached to the adapter device and the adapter device is attached to the ceiling around the hole in the ceiling) and a light-fixture may be attached to the flangeless trim; and bottom surfaces of the installed adapter device and its attached spackle-frame may be finished with plaster to accomplish the flangeless architectural finish for that particular recessed lighting installation that had begun with would have been a too large hole cut into the ceiling that such an adapter device remedies.

It is to these ends that the present invention has been developed.

### BRIEF SUMMARY OF THE INVENTION

To minimize the limitations in the prior art, and to minimize other limitations that will be apparent upon reading and understanding the present specification, embodiments of the present invention may describe an adapter referred to as a downsizer-ring herein, as well as, system(s) and/or kit(s) that may comprise the downsizer-ring and at least one of: a spackle-frame, a flangeless-trim, and/or a light-module (light-source/light-fixture).

With respect to ceiling recessed lighting applications that desire a flangeless trim finish, embodiments of the present invention may be an adapter, referred to herein as a downsizer-ring, that is used to bridge (span) a gap in a ceiling-hole when that ceiling-hole is too large to use a spackle-frame because the outside-diameter of that spackle-frame is less than a diameter of that ceiling-hole. In some embodiments, the downsizer-ring (adapter) may be configured to: (1) attach to the ceiling centered around the ceiling-hole; and (2) attach to the spackle-frame. In some embodiments, the spackle-frame, attached to the downsizer-ring (adapter) (that is attached to the ceiling around the ceiling-hole), may then be used normally, e.g., receiving and attaching a flangeless-trim to the spackle-frame, and then attaching light-source into and to the flangeless-trim (that is attached to the spackle-frame). In some embodiments, bottom surfaces of the downsizer-ring (adapter), with attached spackle-frame, may be plastered over (e.g., to achieve the desired flangeless ceiling recessed lighting finish). In some embodiments, the downsizer-ring (adapter) may comprise two main structures, a main-disc and a raised-platform extending from and above the main-disc. In some embodiments, a bottom of the main-disc comprises an interior-volume of void (hollow) space that is configured to fit at least a portion of the spackle-frame within that interior-volume, such that bottom surfaces of the downsizer-ring (adapter), with attached spackle-frame, may be at least substantially (mostly flush with each other (which facilitates the plastering over step of installation).

It is an objective of the present invention to provide a solution to a problem when an outside-diameter of a spackle-frame is less than a diameter of a ceiling-hole, such that without the solution that spackle-frame could not be used with that ceiling-hole.

It is another objective of the present invention to provide a solution to a problem when an outside-diameter of a spackle-frame is less than a diameter of a ceiling-hole, such that without the solution that spackle-frame could not be used with that ceiling-hole; wherein that solution is an adapter, a downsizer-ring, that is configured to span (bridge) a gap between the ceiling-hole and the spackle-frame.

It is another objective of the present invention to provide a solution to a problem when an outside-diameter of a spackle-frame is less than a diameter of a ceiling-hole, such that without the solution that spackle-frame could not be used with that ceiling-hole; wherein that solution is an adapter, a downsizer-ring, wherein that downsizer-ring is configured to be attached to a ceiling (and centered around the ceiling-hole).

It is another objective of the present invention to provide a solution to a problem when an outside-diameter of a spackle-frame is less than a diameter of a ceiling-hole, such that without the solution that spackle-frame could not be used with that ceiling-hole; wherein that solution is an adapter, a downsizer-ring, wherein that downsizer-ring is configured to be attached to the spackle-frame.

It is another objective of the present invention to provide a solution to a problem when an outside-diameter of a spackle-frame is less than a diameter of a ceiling-hole, such that without the solution that spackle-frame could not be used with that ceiling-hole; wherein that solution is an adapter, a downsizer-ring, wherein when the downsizer-ring is attached to the ceiling (and centered around the ceiling-hole) and the spackle-frame is attached to that downsizer-ring, that spackle-frame may be used normally (as intended) by having a flangeless-trim attached to the spackle-frame and having a bottom surface of the spackle-frame be plastered over.

It is another objective of the present invention to provide a downsizer-ring that is configured to be attached to a ceiling centered around a hole in the ceiling.

It is another objective of the present invention to provide a downsizer-ring that is configured to be attached to a spackle-frame.

It is another objective of the present invention to provide a downsizer-ring that is configured to receive at least a portion of a spackle-frame within a hollow (void) interior-volume of the downsizer-ring.

It is another objective of the present invention to provide a downsizer-ring that is configured to have its bottom surface plastered over.

It is another objective of the present invention to provide a downsizer-ring that is quick, easy, and relatively affordable to manufacture.

It is another objective of the present invention to provide a downsizer-ring that is configured to be manufactured in high volumes (quantities).

It is yet another objective of the present invention to provide a downsizer-ring that is quick and easy to use.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A is a top-down perspective view (top perspective view) of a downsizer-ring (downsizer-adapter) (according to at least one embodiment).

FIG. 1B is a top-down view (top view) of the downsizer-ring of FIG. 1A.

FIG. 1C is a side view (e.g., a right-side view and/or a left-side view) of the downsizer-ring of FIG. 1A. FIG. 1C may also be a front view (or rear view) of the downsizer-ring of FIG. 1A.

FIG. 1D is a bottom-up perspective view (bottom perspective view) of the downsizer-ring of FIG. 1A.

FIG. 1E is an enlarged detailed view of a region from FIG. 1A identified in FIG. 1A as Detail 1E.

FIG. 1F is an enlarged detailed view of a region from FIG. 1D identified in FIG. 1D as Detail 1F.

FIG. 1G is a bottom view of the downsizer-ring of FIG. 1A.

FIG. 2A shows a top-down perspective view (top perspective view) of a given assembly that may comprise the downsizer-ring of FIG. 1A, according to at least one embodiment.

FIG. 2B shows a bottom-up perspective view (bottom perspective view) of the assembly of FIG. 2A.

FIG. 3A is a bottom perspective exploded view of the assembly of FIG. 2A.

FIG. 3B is a side view (or a front view or a rear view) exploded view of the assembly of FIG. 2A.

FIG. 4A is a bottom perspective view of an installation step, showing an initial process of attaching (or preparing to attach) a given spackle-frame to a given downsizer-ring.

FIG. 4B is a bottom perspective view of an installation step 403 of attaching (securing) a spackle-frame to an interior-volume of a downsizer-ring using at least one (one or more) mechanical-fastener(s).

FIG. 4C is a bottom perspective view showing how a given downsizer-ring (with or without an attached spackle-frame) may be attached to a bottom portion (region or section) of a given ceiling (and centered around a hole in that ceiling).

FIG. 4D is a bottom perspective view showing a given downsizer-ring (with or without an attached spackle-frame) has been fitted to the bottom portion (region or section) of the given ceiling (and centered around a hole in that ceiling) and is ready to receive mechanical-fastener(s) to attach (secure) that downsizer-ring to that bottom portion of that ceiling.

FIG. 4E is a bottom perspective view showing plaster being applied by a tool to bottom surfaces of an installed downsizer-ring, an installed spackle-frame, and to ceiling portions for generating a flangeless trim recessed light fixture installation.

FIG. 4F is a bottom perspective view showing a step of connecting a given flangeless-trim-subassembly to a given light-fixture (light-module).

FIG. 4G is a bottom perspective view showing a step of making an electrical connecting between the given light-fixture (light-module) wiring and an electrical connector/wiring from the building.

FIG. 4H is a bottom perspective view showing a step of pushing and/or inserting a subassembly (e.g., of the flangeless-trim-subassembly and an attached light-fixture) at least partially into and/or above a void-space above the hole in the ceiling and through the largest central hole in the spackle-frame (wherein that spackle-frame is attached to the downsizer-ring, that downsizer-ring is attached to the ceiling, and bottom surfaces of the spackle-frame and the downsizer-ring are plastered over so are not visible in FIG. 4H but are present in FIG. 4H).

### REFERENCE NUMERAL SCHEDULE

100 downsizer-ring 100 (downsizer-adapter 100)
101 main-disc 101 (largest-disc 101)
103 raised-platform 103
105 outside-diameter 105
107 outside-edge 107
109 top-surface 109
111 bottom-surface 111
113 height-of-main-disc 113 (thickness 113)
115 inside-boundary 115
117 outwards curving element 117
119 hole-for-fastener 119
121 smallest-hole 121
123 top-surface 123
125 height-of-raised-platform 125 (thickness 125)
127 outside-width 127
129 outside-edge 129
131 bottom-surface 131
133 inside-edge 133 (largest-hole 133)
135 inside-diameter 135
137 center 137
139 slot 139
141 hole-for-fastener 141
143 smallest-hole 143
145 interior-edge 145
147 interior-volume 147
149 width-of-interior-volume 149
151 diameter-of-interior-volume 151
153 depth-of-interior-volume (height-of-interior-volume) 153
200 assembly 200 (system 200/kit 200)
201 spackle-frame 201
203 flangeless-trim-subassembly 203
205 light-module 205
207 mechanical-fastener(s) 207
209 aperture-of-spackle-frame 209
211 outside-diameter-of-spackle-frame 211
213 upward-extending-collar 213
214 diameter-of-upward-extending-collar 214
215 clips 215
300 subassembly 300
401 step of inserting spackle-frame into interior-volume of downsizer-ring 401
402 insert 402
403 step of attaching spackle-frame to interior-volume of downsizer-ring 403
404 mechanical-fastener 404
405 step of fitting downsizer-ring to hole in ceiling 405
406 ceiling 406
417 hole-in-ceiling 417
418 diameter-of-hole-in-ceiling 418
419 insert (fitting) 419
407 step of attaching downsizer-ring to ceiling center around hole in ceiling 407
409 step of plastering (applying plaster) bottom surfaces 409
421 plaster (mud and/or spackle) 421
423 tool 423
425 void-space 425
411 step of connecting flangeless-trim-subassembly to light-fixture (form subassembly) 411
427 wall(s) 427
413 step of making electrical connection 413
429 plastered-ceiling 429
415 step of inserting a subassembly at least partially into and/or above a void-space 415
431 pushing/inserting 431

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

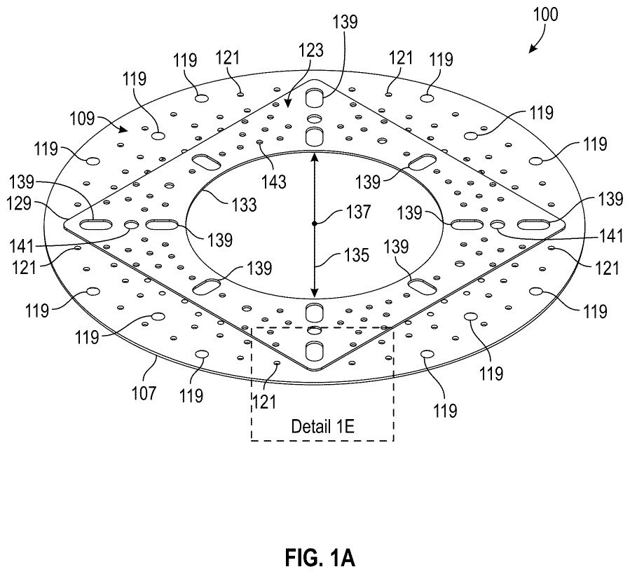

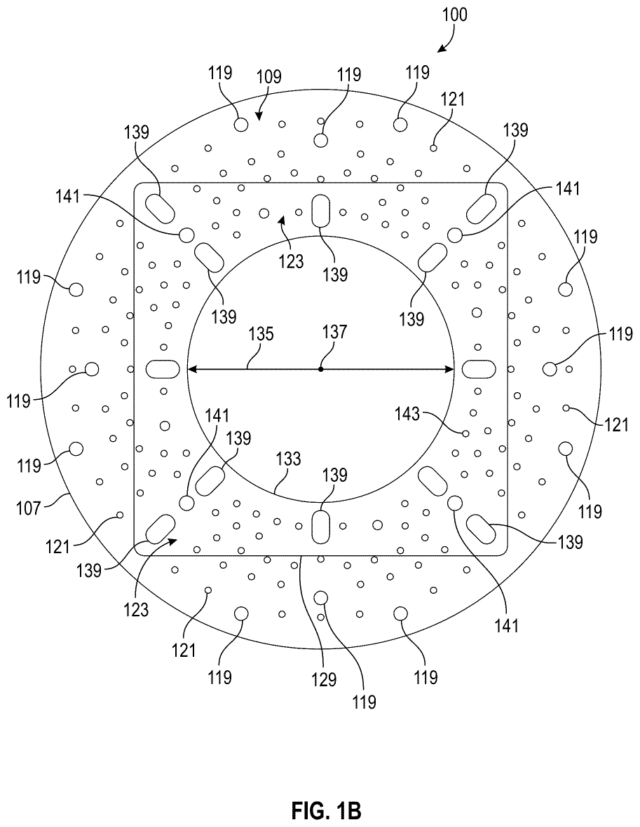

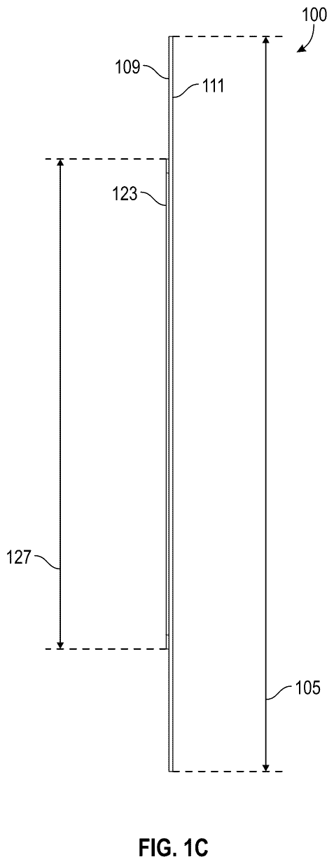

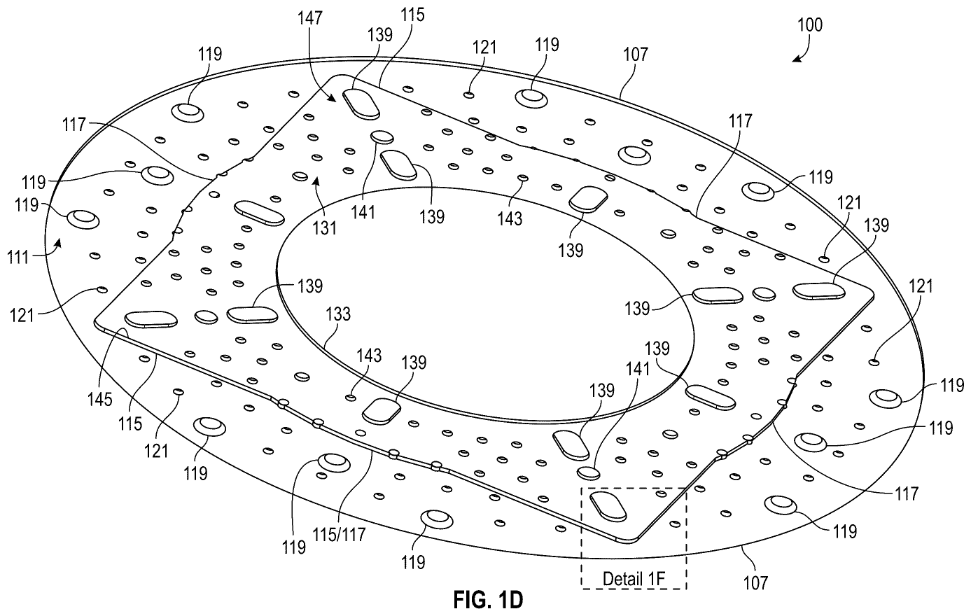

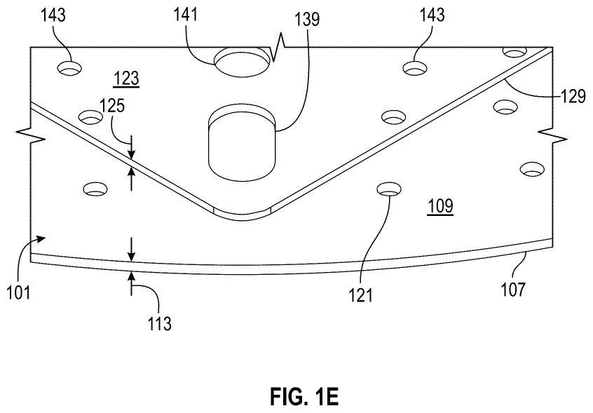

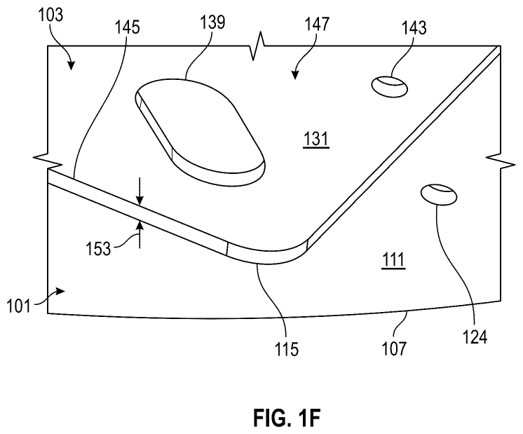

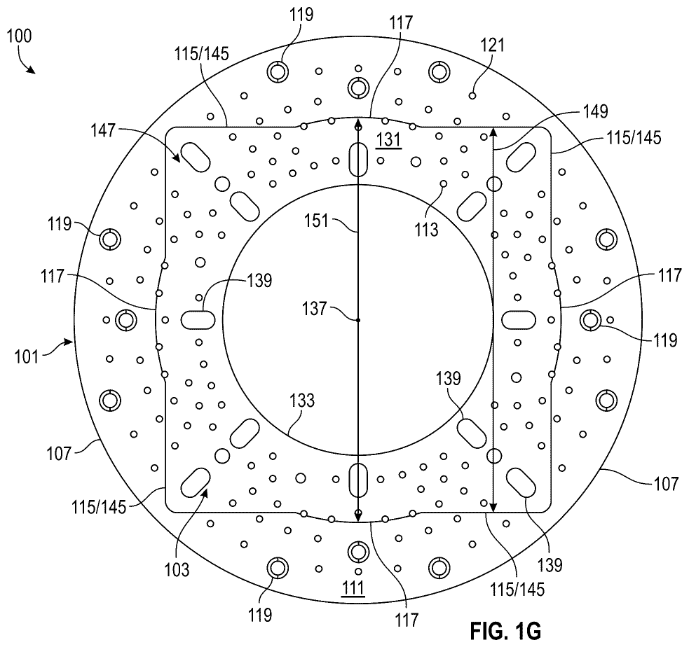

FIG. 1A is a top-down perspective view of a downsizer-ring 100 (downsizer-adapter 100) (according to at least one embodiment). “Downsizer-ring” may be used interchangeably with “downsizer-adapter” herein. Note, a purpose and/or a function of downsizer-ring 100 may be shown in figures after FIG. 1G. How downsizer-ring 100 may interact and/or communicate with other structures, assemblies, parts, and/or components may be shown in figures after FIG. 1G. FIG. 1B is a top-down view (top view) of downsizer-ring 100. FIG. 1C is a side view (e.g., right-side view and/or left-side view) of downsizer-ring 100. FIG. 1C is also a front view (or rear view) of downsizer-ring 100. FIG. 1D is a bottom-up perspective view (bottom perspective view) of downsizer-ring 100. FIG. 1E is an enlarged detailed view of a region from FIG. 1A identified in FIG. 1A as Detail 1E. FIG. 1F is an enlarged detailed view of a region from FIG. 1D identified in FIG. 1D as Detail 1F. FIG. 1G is a bottom view of downsizer-ring 100. In some embodiments, downsizer-ring 100 may comprise two main structural and/or geometric regions, namely, main-disc 101 and raised-platform 103. In some embodiments, downsizer-ring 100 may be a single article of manufacture that may comprise main-disc 101 and raised-platform 103.

Discussing main-disc 101 shown in FIG. 1A to FIG. 1G, “main-disc” may be used interchangeably with “largest-disc” herein. In some embodiments, main-disc 101 may comprise a disc (disk) shape (e.g., with respect to an outside-edge 107, a top-surface 109, and/or a bottom-surface 111 of main-disc 101). In some embodiments, main-disc 101 may comprise an annular disc (disk) shape (e.g., with respect to an outside-edge 107, a top-surface 109, and/or a bottom-surface 111 of main-disc 101). In some embodiments, main-disc 101 may comprise a right cylinder shape (e.g., with respect to an outside-edge 107, a top-surface 109, and/or a bottom-surface 111 of main-disc 101). In some embodiments, main-disc 101 may comprise a right cylindrical shape (e.g., with respect to an outside-edge 107, a top-surface 109, and/or a bottom-surface 111 of main-disc 101). In some embodiments, main-disc 101 may have a three-dimensional (3D) shape of at least one of: a disc (disk), annular disc (disk), right cylinder, right cylindrical, combinations thereof, and/or the like (e.g., with respect to an outside-edge 107, a top-surface 109, and/or a bottom-surface 111 of main-disc 101). In some embodiments, main-disc 101 may have a three-dimensional (3D) shape that is substantially (mostly) of at least one of: a disc (disk), annular disc (disk), right cylinder, right cylindrical, combinations thereof, and/or the like (e.g., with respect to an outside-edge 107, a top-surface 109, and/or a bottom-surface 111 of main-disc 101). In some embodiments, main-disc 101 may comprise an outside-diameter 105. This outside-diameter 105 may be shown (visible) in FIG. 1A to FIG. 1D, but is specifically called by reference numeral in FIG. 1C. In some embodiments, outside-diameter 105 may be an outside diameter of main-disc 101. In some embodiments, outside-diameter 105 may be a largest diameter of main-disc 101. In some embodiments, outside-diameter 105 may be a largest dimension of main-disc 101. In some embodiments, for a given main-disc 101, outside-diameter 105 may be predetermined, uniform, fixed, finite, non-variable.

Continuing discussing main-disc 101 shown in FIG. 1A to FIG. 1G, in some embodiments, running around an outside perimeter of outside-diameter 105 may be outside-edge 107. In some embodiments, outside-edge 107 may be an outside edge and/or an outside perimeter surface of main-disc 101. In some embodiments, outside-edge 107 may be disposed between a top-surface 109 of main-disc 101 and a bottom-surface 111 of main-disc 101. In some embodiments, top-surface 109 may be planarly flat surface. In some embodiments, bottom-surface 111 may be planarly flat surface. In some embodiments, main-disc 101 may be a planar member; i.e., bottom-surface 111 may lay flat up against a flat surface (and/or top-surface 109 may lay flat up against a flat surface if raised-platform 103 were not present). In some embodiments, a projection from a top view or a bottom view of main-disc 101 results in a closed circle with outside-diameter 105; a projection of outside-edge 107 from a top view or from a bottom view, results in a closed circle with outside-diameter 105 (see e.g., FIG. 1B). In some embodiments, outside-edge 107 may have a height 113 (thickness 113). In some embodiments, disposed between top-surface 109 and bottom-surface 111 may be height 113 (thickness 113). In some embodiments, top-surface 109 and bottom-surface 111 may be oppositely disposed surfaces from each other, separated from each other by height 113 (thickness 113). In some embodiments, for a given main-disc 101, height 113 (thickness 113) may be predetermined, uniform, fixed, finite, non-variable. In some embodiments, height 113 (thickness 113) may be smaller than outside-diameter 105. In some embodiments, height 113 (thickness 113) may be substantially smaller than outside-diameter 105. In some embodiments, the bottom-surface 111 may comprise an inside-boundary 115 that may define where main-disc 101 ends and where an interior-volume 147 of hollow (void) space exists within a bottom of main-disc 101 (see e.g., FIG. 1D and FIG. 1G for interior-volume 147). In some embodiments, inside-boundary 115 may trace (be) a two-dimensional (2D) closed shape that substantially (mostly) resembles a square, with four sides (i.e., two pairs of perpendicular sides, with each pair of oppositely disposed sides being parallel with each other), with rounded corners, and where rein each of the four sides comprises an outwards curving element 117. In some embodiments, because there may be four separate and distinct sides of inside-boundary 115, there are four separate and distinct curving elements 117, one curving element 117 per side of inside-boundary 115. In some embodiments, a given outwards curving element 117 curves towards a closest outside-edge 107 portion. In some embodiments, each outwards curving element 117 may be located in a center of its side of inside-boundary 115.

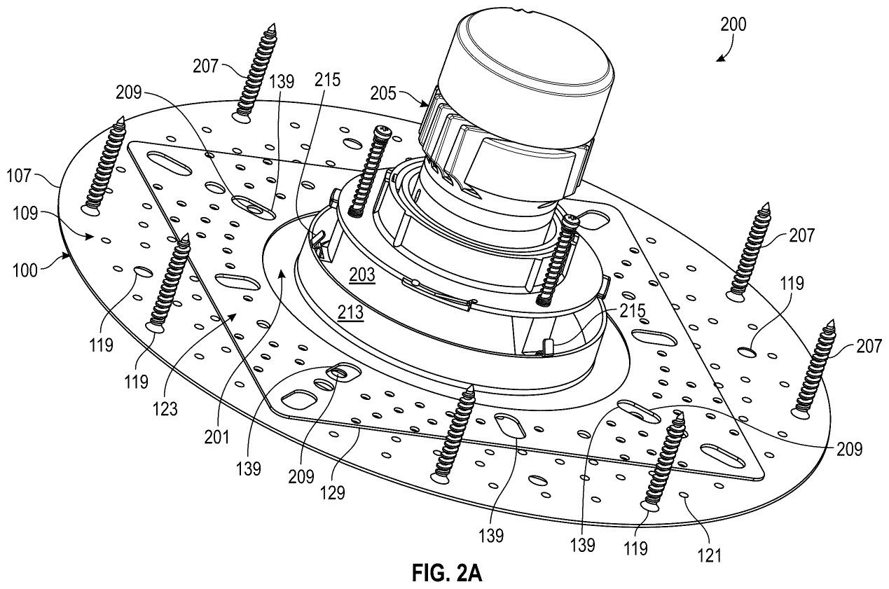

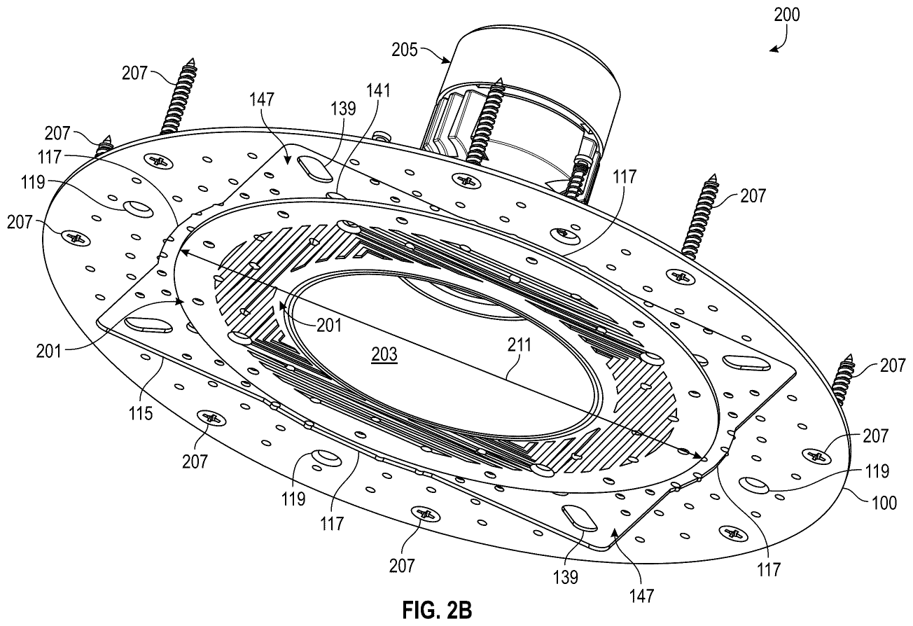

Continuing discussing main-disc 101 shown in FIG. 1A to FIG. 1G, in some embodiments, height-of-main-disc 113 (thickness 113) may be solid and/or made of solid material(s), aside from where hole(s)-for-fastener(s) 119 and/or smallest-hole(s) 121 may pass entirely through main-disc 101. In some embodiments, main-disc 101 may comprise at least one (one or more) hole-for-fastener 119 (hole 119). In some embodiments, main-disc 101 may comprise a plurality of holes-for-fasteners 119 (holes 119). In some embodiments, main-disc 101 may comprise at least four (4) to twelve (12) holes-for-fasteners 119 (holes 119). In some embodiments, located on main-disc 101 between a side of inside-boundary 115 and a closest outside-edge 107 region to that side, may be from one (1) to three (3) holes-for-fasteners 119 (holes 119). In some embodiments, hole-for-fastener 119 may be a through hole (aperture) that passes entirely through height 113 (thickness 113) from top-surface 109 to bottom-surface 111 (or from bottom-surface 111 to top-surface 109). In some embodiments, hole-for-fastener 119 may be configured to receive a portion of a given mechanical-fastener 207 (see e.g., FIG. 2A and FIG. 2B for mechanical-fasteners 207) therethrough (such as, but not limited to, a screw, a nail, or the like) (e.g., for securing [attaching] main-disc 101 to a ceiling 406 and/or to drywall or the like). In some embodiments, not every hole-for-fastener 119 of main-disc 101 may need a mechanical-fastener 207 for securing [attaching] main-disc 101 to ceiling 406 and/or to drywall or the like; and any hole(s)-for-fastener(s) 119 that is/are not then receiving a mechanical-fastener 207, may be filled with spackle, joint compound, plaster, and/or the like. In some embodiments, each hole-for-fastener 119 of a given main-disc 101 may have a same size, shape, dimension, and/or inside diameter as all the other hole-for-fastener 119 of that given main-disc 101. In some embodiments, with respect to a given main-disc 101, a size, shape, dimension, and/or inside diameter of its hole(s)-for-fastener(s) 119 may be predetermined, uniform, finite, fixed, same shape, same size, and/or non-variable. In some embodiments, bottom sides of hole(s)-for-fastener(s) 119 (e.g., on bottom-surface 111) may be beveled (around their circumference) for flushly receiving (accepting) screw 207 heads therein.

Continuing discussing main-disc 101 shown in FIG. 1A to FIG. 1G, in some embodiments, main-disc 101 may comprise at least one (one or more) smallest-hole 121 (hole 121). In some embodiments, main-disc 101 may comprise a plurality of smallest-holes 121 (holes 121). In some embodiments, located on main-disc 101 between a side of inside-boundary 115 and a closest outside-edge 107 region to that side, may be a group of smallest-holes 121 (holes 121). In some embodiments, smallest-hole 121 may be a through hole (aperture) that passes entirely through height 113 (thickness 113) from top-surface 109 to bottom-surface 111 (or from bottom-surface 111 to top-surface 109). In some embodiments, smallest-hole(s) 121 may be configured to receive spackle, joint compound, plaster, and/or the like therein. In some embodiments, smallest-hole(s) 121 may be configured to be filled in with spackle, joint compound, plaster, and/or the like. In some embodiments, smallest-hole 121 may not be configured for receiving a portion of a mechanical fastener. In some embodiments, each smallest-hole 121 of a given main-disc 101 may have a same size, shape, dimension, and/or inside diameter as all the other smallest-holes 121 of that given main-disc 101. In some embodiments, with respect to a given main-disc 101, a size, shape, dimension, and/or inside diameter of its smallest-hole(s) 121 may be predetermined, uniform, finite, fixed, same shape, same size, and/or non-variable. In some embodiments, a given smallest-hole 121 (hole 121) may be smaller than given hole-for-fastener 119 (hole 119). In some embodiments, a given smallest-hole 121 (hole 121) may be smaller than given hole-for-fastener 141 (hole 141) (of raised-platform 103). In some embodiments, main-disc 101 may be rigid to substantially (mostly) rigid. In some embodiments, main-disc 101 may comprise at least one of: outside-diameter 105, outside-edge 107, top-surface 109, bottom-surface 111, height-of-main-disc 113 (thickness 113), inside-boundary 115, outwards curving element 117, hole(s)-for-fastener(s) 119, and/or smallest-hole(s) 121. See e.g., FIG. 1A to FIG. 1G for main-disc 101.

Now discussing raised-platform 103 (of downsizer-ring 100) as shown in FIG. 1A to FIG. 1G, in some embodiments, raised-platform 103 may be a raised structure that is on top of main-disc 101 and/or that extends upwards from top-surface 109 of main-disc 101. In some embodiments, raised-platform 103 may comprise a top-surface 123. In some embodiments, top-surface 123 may be above top-surface 109. In some embodiments, top-surface 123 may be planarly flat surface. In some embodiments, top-surface 123 may extend above top-surface 109 by a height 125 (thickness 125) of raised-platform 103. In some embodiments, height 125 (thickness 125) may be a height and/or a thickness of raised-platform 103. In some embodiments, for a given raised-platform 103, height 125 (thickness 125) may be predetermined, uniform, fixed, finite, and/or non-variable. In some embodiments, when viewed from above and/or from a top view, raised-platform 103 may have a square shape (with rounded corners). In some embodiments, raised-platform 103 may have a substantially (mostly) rectangular prism shape, that is square from its top view (with rounded corners), with a height 125 (thickness 125) and a width 127 (outside-width 127). In some embodiments, width 127 (outside-width 127) may be an outside width of raised-platform 103, from one side of raised-platform 103 to an opposite side of raised-platform 103, with respect to a top view of raised-platform 103 and/or with respect to top-surface 123. In some embodiments, width 127 (outside-width 127) may be greater than height 125 (thickness 125) and/or greater than height 113 (thickness 113). In some embodiments, width 127 (outside-width 127) may be less than outside-diameter 105. In some embodiments, outer sides of raised-platform 103 (of its rectangular prism shape) may define outside-edge 129. In some embodiments, outside-edge 129 may be an outside edge of raised-platform 103 that may be disposed between top-surface 123 and a bottom-surface 131 of raised-platform 103. In some embodiments, bottom-surface 131 may be planarly flat surface. In some embodiments, top-surface 123 and bottom-surface 131 may be oppositely disposed surfaces from each other, separated from each other by height 125 (thickness 125). In some embodiments, outside-edge 129 may have a height of height 125 (thickness 125). In some embodiments, outside-edge 129 may run on the four outer main sides of raised-platform 103 and on the outer sides of the rounded corners of raised-platform 103. In some embodiments, raised-platform 103 may run (extend) from outside-edge 129 along top-surface 123 (or along bottom-surface 131) until terminating at inside-edge 133. In some embodiments, inside-edge 133 may be oppositely disposed from outside-edge 129. In some embodiments, inside-edge 133 may be an inside edge (surface) of raised-platform 103. In some embodiments, inside-edge 133 may be disposed between top-surface 123 and bottom-surface 131. In some embodiments, inside-edge 133 may have a height of height 125. In some embodiments, inside-edge 133 may trace a right cylindrical shape (with height 125). In some embodiments, when raised-platform 103 may be viewed from above (top view) or from below (bottom view), inside-edge 133 may have a circle (circular) shape. In some embodiments, inside-edge 133 may have an inside-diameter 135. In some embodiments, inside-diameter 135 may be an inside-diameter of inside-edge 133 and/or of raised-platform 103. In some embodiments, inside-edge 133 may refer to a largest circle and centered opening of raised-platform 103. In some embodiments, reference numeral 133 may refer to the largest circle and centered circle opening of raised-platform 103. In some embodiments, largest-circle-opening 133 and/or diameter 135 may be sized to fit upward-extending-collar 213 and/or diameter 214 (of upward-extending-collar 213) of spackle-frame 201 within largest-circle-opening 133 and/or within diameter 135. In some embodiments, for a given raised-platform 103, inside-diameter 135 may be predetermined, uniform, fixed, finite, and/or non-variable. In some embodiments, inside-diameter 135 may be less than outside-width 127. In some embodiments, inside-diameter 135 may be greater than height 125 (thickness 125) and/or greater than height 113 (thickness 113). In some embodiments, raised-platform 103 may have a main (largest) circular opening defined by inside-edge 133 and its inside-diameter 135. In some embodiments, raised-platform 103 may have a main (largest) and centered circular opening defined by inside-edge 133 and its inside-diameter 135, centered about center 137. In some embodiment, center 137 may be a shared (common) center point of downsizer-ring 100, of main-disc 101, and/or of raised-platform 103; note, center 137 does not reside on any actual physical structure of downsizer-ring 100, of main-disc 101, and/or of raised-platform 103.

Continuing discussing raised-platform 103 shown in FIG. 1A to FIG. 1G, in some embodiments, height-of-main-disc 125 (thickness 125) may be solid and/or made of solid material(s), aside from where slot(s) 139, hole(s)-for-fastener(s) 141, and/or smallest-hole(s) 143 may pass entirely through raised-platform 103. In some embodiments, raised-platform 103 may comprise at least one (one or more) slot(s) 139. In some embodiments, raised-platform 103 may comprise a plurality of slots 139. In some embodiments, raised-platform 103 may comprise from at least one (1) to two (2) slot(s) 139 at each rounded corner of 103. In some embodiments, at a middle of each edge 129 (of raised-platform 103) and inset from the middle edge 129 location may be one slot 139. In some embodiments, slot 139 may be a through hole (aperture), in a slot shape (elongate shape), that passes entirely through height 125 (thickness 125) from top-surface 123 to bottom-surface 131 (or from bottom-surface 131 to top-surface 123). In some embodiments, slot(s) 139 may be oriented on raised-platform 103 such that each of their lengths may linearly point at (towards) center 137. In some embodiments, slot 139 may be configured to receive a portion of a given mechanical fastener therethrough (such as, but not limited to, a screw, a nail, or the like) (e.g., for securing [attaching] a spackle-frame 201 to raised-platform 103 [see e.g., FIG. 2B for spackle-frame 201]). In some embodiments, the slot shape of a given slot 139 may permit an easier time with respect to installing a given spackle-frame 201 to that raised-platform 103, as the slot shape of slot(s) 139 inherently do not require perfect alignment with hole(s) 209 of spackle-frame 201; i.e., the slot shape of slot(s) 139 permits some wiggle room with respect to installing a given spackle-frame 201 to a raised-platform 103. In some embodiments, not every slot 139 of raised-platform 103 may need a mechanical fastener for securing [attaching] spackle-frame 201 to raised-platform 103; and any slot(s) 139 that is/are not then receiving a mechanical fastener, may be filled with spackle, joint compound, plaster, and/or the like. In some embodiments, each slot 139 of a given raised-platform 103 may have a same size, shape, dimension, and/or inside diameter as all the other slots 139 of that given raised-platform 103. In some embodiments, with respect to a given raised-platform 103, a size, shape, dimension, and/or inside diameter of its slot(s) 139 may be predetermined, uniform, finite, fixed, same shape, same size, and/or non-variable. In some embodiments, there may be no slots 139 located on main-disc 101.

Continuing discussing raised-platform 103 shown in FIG. 1A to FIG. 1G, in some embodiments, raised-platform 103 may comprise at least one (one or more) hole-for-fastener 141 (hole 141). In some embodiments, raised-platform 103 may comprise a plurality of holes-for-fasteners 141 (holes 141). In some embodiments, raised-platform 103 may comprise four (4) holes-for-fasteners 141 (holes 141). In some embodiments, hole-for-fastener 141 may be a through hole (aperture) that passes entirely through height 125 (thickness 125) from top-surface 123 to bottom-surface 131 (or from bottom-surface 131 to top-surface 123). In some embodiments, hole-for-fastener 141 may be configured to receive a portion of a given mechanical fastener therethrough (such as, but not limited to, a screw, a nail, or the like) (e.g., for securing [attaching] a spackle-frame 201 to raised-platform 103 [see e.g., FIG. 2B for spackle-frame 201]). In some embodiments, not every hole-for-fastener 141 of raised-platform 103 may need a mechanical fastener for securing [attaching] spackle-frame 201 to raised-platform 103; and any hole(s)-for-fastener(s) 141 that is/are not then receiving a mechanical fastener, may be filled with spackle, joint compound, plaster, and/or the like. In some embodiments, each hole-for-fastener 141 of a given raised-platform 103 may have a same size, shape, dimension, and/or inside diameter as all the other holes-for-fasteners 141 of that given raised-platform 103. In some embodiments, with respect to a given raised-platform 103, a size, shape, dimension, and/or inside diameter of its hole(s)-for-fastener(s) 141 may be predetermined, uniform, finite, fixed, same shape, same size, and/or non-variable. In some embodiments, the size, shape, diameter, and/or dimension of hole(s) 141 may be at least substantially (mostly) the same to identical with the size, shape, diameter, and/or dimension of hole(s) 119 (of main-disc 101).

Continuing discussing raised-platform 103 shown in FIG. 1A to FIG. 1G, in some embodiments, raised-platform 103 may comprise at least one (one or more) smallest-hole 143 (hole 143). In some embodiments, raised-platform 103 may comprise a plurality of smallest-holes 143 (holes 143). In some embodiments, smallest-hole 143 may be a through hole (aperture) that passes entirely through height 125 (thickness 125) from top-surface 123 to bottom-surface 131 (or from bottom-surface 131 to top-surface 123). In some embodiments, smallest-hole(s) 143 may be configured to receive spackle, joint compound, plaster, and/or the like therein. In some embodiments, smallest-hole(s) 143 may be configured to be filled in with spackle, joint compound, plaster, and/or the like. In some embodiments, smallest-hole 143 may not be configured for receiving a portion of a mechanical fastener. In some embodiments, each smallest-hole 143 of a given raised-platform 103 may have a same size, shape, dimension, and/or inside diameter as all the other smallest-holes 143 of that given raised-platform 103. In some embodiments, with respect to a given raised-platform 103, a size, shape, dimension, and/or inside diameter of its smallest-hole(s) 143 may be predetermined, uniform, finite, fixed, same shape, same size, and/or non-variable. In some embodiments, a given smallest-hole 143 (hole 143) may be smaller than given hole-for-fastener 141 (hole 141). In some embodiments, a given smallest-hole 143 (hole 143) may be smaller than given hole-for-fastener 119 (hole 119) (of main-disc 101). In some embodiments, the size, shape, diameter, and/or dimension of hole(s) 143 may be at least substantially (mostly) the same to identical with the size, shape, diameter, and/or dimension of hole(s) 121 (of main-disc 101). In some embodiments, raised-platform 103 may be rigid to substantially (mostly) rigid. In some embodiments, raised-platform 103 may comprise at least one of: top-surface 123, height-of-raised-platform 125 (thickness 125), outside-width 127, outside-edge 129, bottom-surface 131, inside-edge 133, inside-diameter 135, slot(s) 139, hole(s)-for-fastener(s) 141, and/or smallest-hole(s) 143. See e.g., FIG. 1A to FIG. 1G for raised-platform 103.

Continuing discussing downsizer-ring 100 and with respect to FIG. 1D and/or FIG. 1G, the bottom perspective view or the bottom view of downsizer-ring 100, respectively, in some embodiments, downsizer-ring 100 (and/or main-disc 101) may comprise interior-edge 145. In some embodiments, interior-edge 145 may extend (linearly straight) upwards from inside-boundary 115 and towards bottom-surface 131 (and/or towards top-surface 123). In some embodiments, height 113 (thickness 113) may be a height of interior-edge 145; i.e., interior-edge 145 may extend (linearly straight) upwards from inside-boundary 115 and towards bottom-surface 131 (and/or towards top-surface 123) by height 113 (thickness 113). In some embodiments, interior-edge 145 may have the exact same shape profile as inside-boundary 115. Where outside-edge 129 may be visible from upper views of raised-platform 103 (and/or of downsizer-ring 100), interior-edge 145 may be visible from lower (underside) views of downsizer-ring 100 and/or from main-disc 101. Where outside-edge 129 may be outwards facing, interior-edge 145 may be interior facing. In some embodiments, interior-edge 145 may face towards inside-edge 133; whereas, outside-edge 129 may face away from inside-edge 133.

Continuing discussing downsizer-ring 100 and with respect to FIG. 1D and/or FIG. 1G, in some embodiments, downsizer-ring 100 (and/or main-disc 101) may comprise an interior-volume 147. In some embodiments, interior-volume 147 may be a region (portion and/or section) of main-disc 101 of void space, hollow space, hollow volume, hollow space, and/or empty space. In some embodiments, interior-volume 147 may be configured to receive therein a spackle-frame 201 (e.g., as shown in FIG. 2B). Continuing discussing FIG. 1D and/or FIG. 1G, in some embodiments, interior-volume 147 may be bound arounds its sides (periphery) by interior-edge 145. In some embodiments, interior-volume 147 may be bound at it top by bottom-surface 131 of raised-platform 103; i.e., bottom-surface 131 may act as a roof and/or as a ceiling to interior-volume 147. In some embodiments, interior-volume 147 may have a height of height 113 (thickness 113). In some embodiments, all heights of interior-volume 147 may be height 113 (thickness 113). In some embodiments, interior-volume 147 may be completely open at its bottom (for receiving spackle-frame 201 within interior-volume 147) and partially open at its top where the circular opening defined by inside-edge 133 of raised-platform 103 is located. In some embodiments, interior-volume 147 (and/or main-disc 101) may comprise: width-of-interior-volume 149 (width 149) and diameter-of-interior-volume 151 (diameter 151); wherein both of these reference numerals are explicitly called out (shown) in FIG. 1G. In some embodiments, width-of-interior-volume 149 may be a width of interior-volume 147. In some embodiments, width-of-interior-volume 149 may be from one side of interior-volume 147 to an opposing side of interior-volume 147. In some embodiments, width-of-interior-volume 149 may be from one linearly straight side of interior-volume 147 to an opposing linearly straight side of interior-volume 147. In some embodiments, width-of-interior-volume 149 may be from one side (e.g., one interior-edge 145 side) of interior-volume 147 to an opposing side (e.g., an opposing interior-edge 145 side) of interior-volume 147. In some embodiments, width-of-interior-volume 149 may be from one linearly straight side (e.g., one interior-edge 145 side) of interior-volume 147 to an opposing linearly straight side (e.g., an opposing interior-edge 145 side) of interior-volume 147. In some embodiments, with respect to a given downsizer-ring 100 (and/or main-disc 101), width-of-interior-volume 149 (width 149) may be predetermined, uniform, finite, fixed, and/or non-variable. In some embodiments, width-of-interior-volume 149 may be larger than (greater than) outside-width 127 (of raised-platform 103). In some embodiments, width-of-interior-volume 149 may be less than (smaller than) outside-diameter 105 (of main-disc 101). In some embodiments, width-of-interior-volume 149 may be less than (smaller than) diameter-of-interior-volume 151 (of interior-volume 147). In some embodiments, diameter-of-interior-volume 151 (diameter 151) may be a diameter of interior-volume 147, that extends from one outwardly curved sidewall interior-edge 145 of interior-volume 147 to an opposing curved sidewall interior-edge 145 of interior-volume 147. In some embodiments, each of the four sides interior-edge 145 of interior-volume 147, at a middle section of each side, may be one outwardly curved sidewall interior-edge 145 that extends upwards (towards bottom-surface 131 and/or towards top-surface 109) from a given outwards curving element 117 (of inside-boundary 115 of main-disc 101). In some embodiments, diameter-of-interior-volume 151 may be larger than (greater than) inside-diameter 135 (of raised-platform 103). In some embodiments, diameter-of-interior-volume 151 may be larger than (greater than) a largest (outside) diameter 211 of spackle-frame 201. In some embodiments, diameter-of-interior-volume 151 may be less than (smaller than) outside-diameter 105 (of main-disc 101).

With respect to relationships between downsizer-ring 100, main-disc 101, and raised-platform 103, in some embodiments, main-disc 101 and raised-platform 103 may be integrally attached (connected) to each other, to form downsizer-ring 100. In some embodiments, raised-platform 103 may be disposed (located) on top of main-disc 101. In some embodiments, raised-platform 103 may be an upper most portion of downsizer-ring 100. In some embodiments, main-disc 101 may be a lower most portion of downsizer-ring 100. In some embodiments, raised-platform 103 may be located within an outer boundary (perimeter) of main-disc 101. See e.g., FIG. 1A to FIG. 1G.

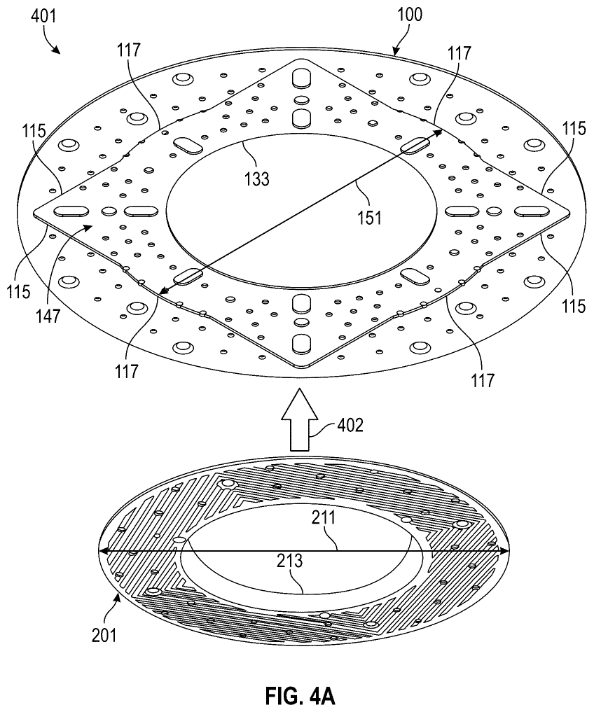

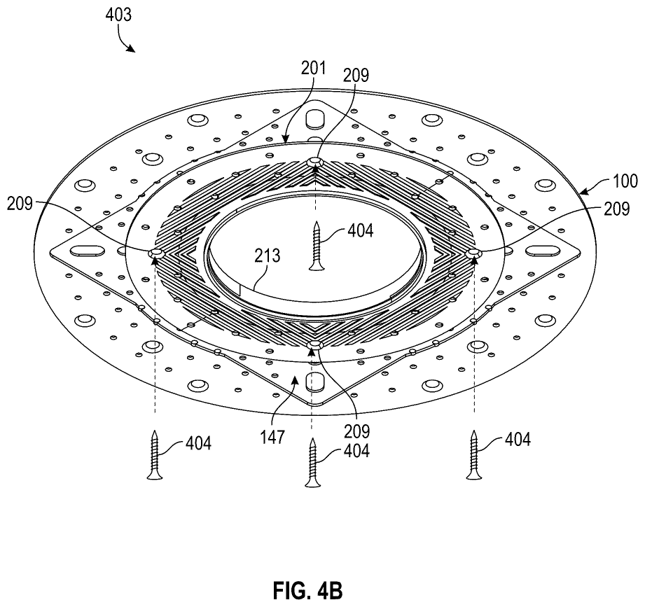

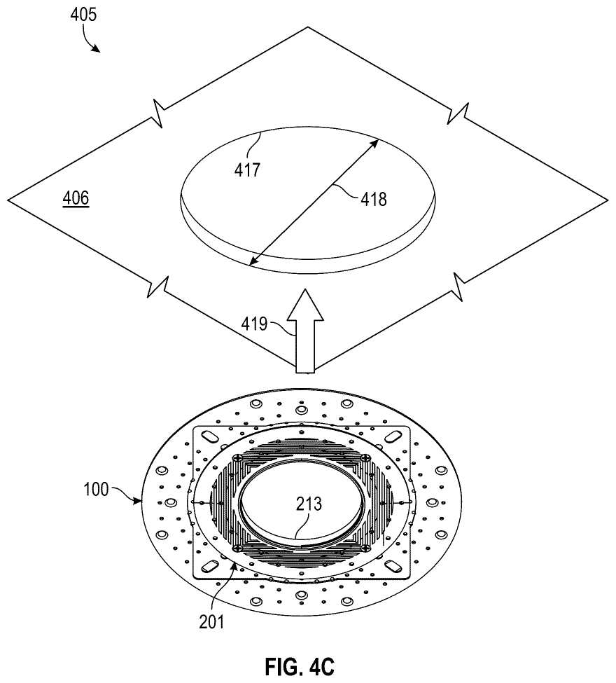

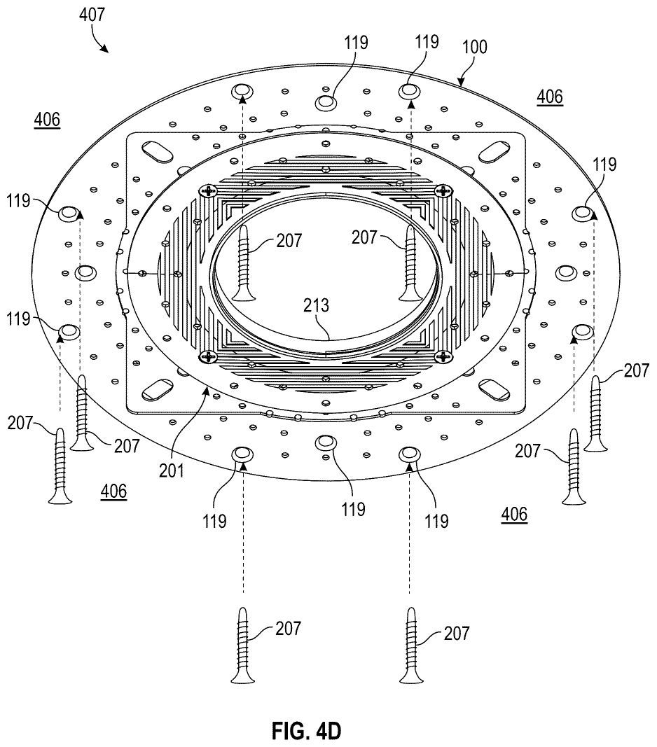

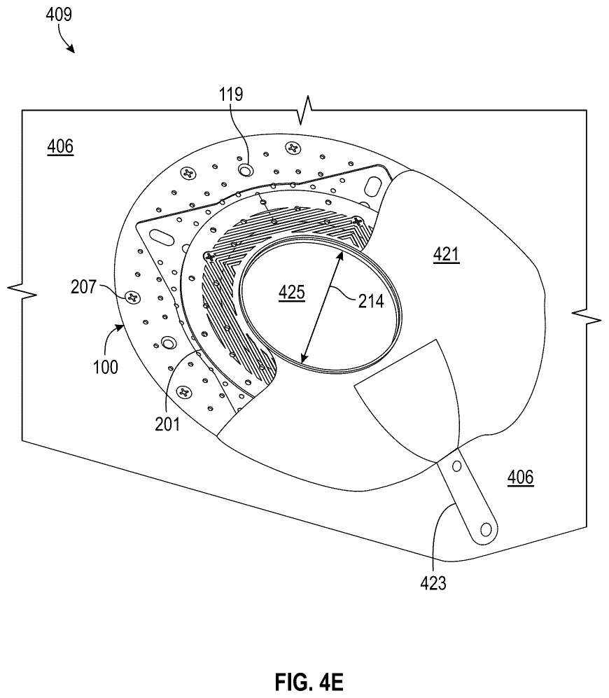

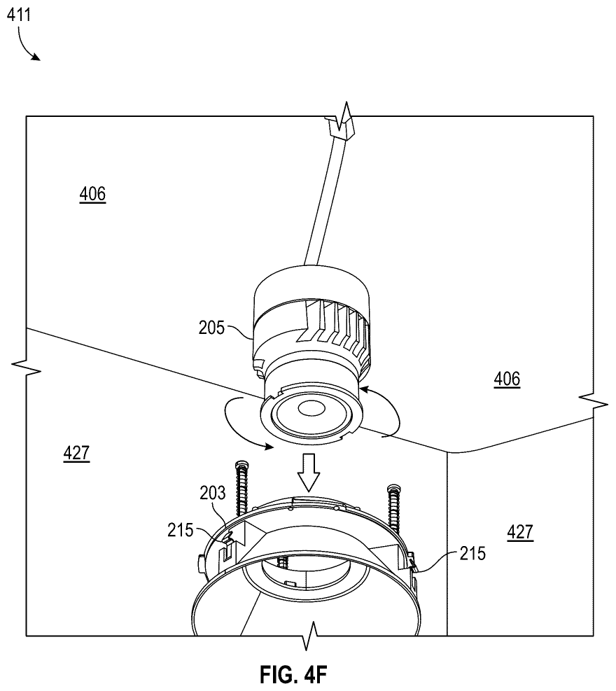

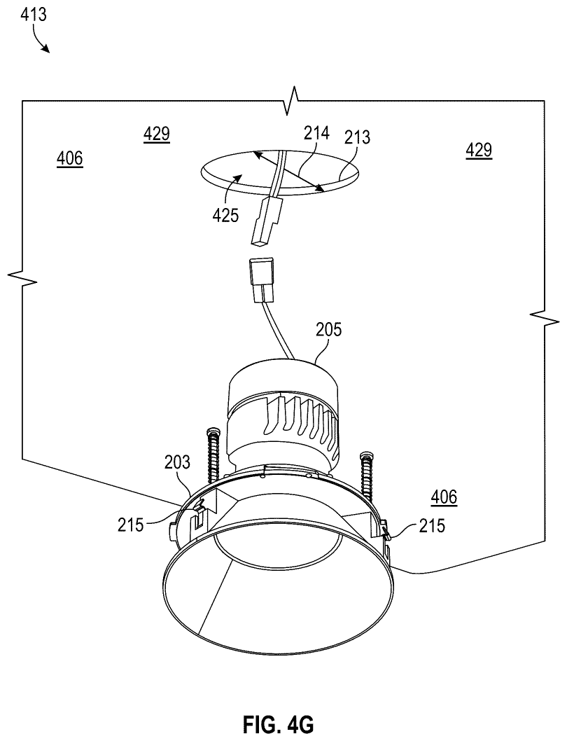

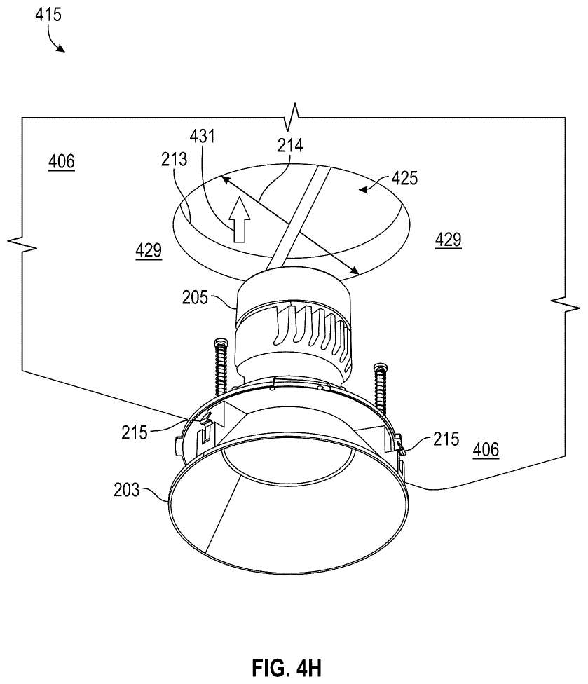

FIG. 2A shows a top-down perspective view (top perspective view) of a given assembly 200, according to at least one embodiment. FIG. 2B shows a bottom-up perspective view (bottom perspective view) of assembly 200. In some embodiments, FIG. 2A and FIG. 2B may show assembly 200 in an assembled configuration (however, mechanical-fasteners 404 are omitted in FIG. 2A and FIG. 2B but are shown in FIG. 4B). In some embodiments, assembly 200 may also be referred to as system 200 and/or as kit 200. In some embodiments, assembly 200 may comprise: one (1) downsizer-ring 100; one (1) spackle-frame 201; one (1) flangeless-trim-subassembly 203; and one (1) light-module 205. In some embodiments, assembly 200 may comprise: one (1) downsizer-ring 100; one (1) spackle-frame 201; one (1) flangeless-trim-subassembly 203; one (1) light-module 205; and at least one mechanical-fastener 207. In some embodiments, assembly 200 may comprise: one (1) downsizer-ring 100; one (1) spackle-frame 201; one (1) flangeless-trim-subassembly 203; one (1) light-module 205; at least one mechanical-fastener 207; and at least one mechanical-fastener 404 (see e.g., FIG. 4B for mechanical-fastener 404). Note, spackle-frame 201 is only partially visible in FIG. 2A (e.g., some of its apertures 209 are visible in FIG. 2A) and spackle-frame 201 is more visible in FIG. 2B. FIG. 2B shows the planarly flat, annular disc, and/or flange structure/geometry of spackle-frame 201 residing entirely within interior-volume 147 of downsizer-ring 100 (and/or main-disc 101).

Note in some embodiments, the “spackle-frame 201” shown and described in this present (instant) patent application may be the same as a “spackle-frame 201” shown and described in U.S. utility U.S. Pat. No. 11,662,084 (that both of their reference numerals are the same is coincident). The teachings and disclosures of U.S. utility U.S. Pat. No. 11,662,084 are incorporated herein as if fully set forth herein. Note in some embodiments, the “flangeless-trim-subassembly 203” shown and described in this present (instant) patent application may be a combination of a “reflector 223,” a “holding-plate 241 (mounting-plate) 241,” and a “trim 321” as shown and described in U.S. utility U.S. Pat. No. 11,662,084. Note in some embodiments, the “light-module 205” shown and described in this present (instant) patent application may be the same as a “lighting module assembly 500” as shown and described in U.S. utility U.S. Pat. No. 11,662,084.

Continuing discussing FIG. 2A and FIG. 2B, in some embodiments, spackle-frame 201 may be attached to downsizer-ring 100 via mechanical-fastener(s) 404 (e.g., as shown in FIG. 4B). In some embodiments, light-module 205 and flangeless-trim-subassembly 203 may be attached to each other for form a sub-assembly 300 as shown in FIG. 2A, in FIG. 4F, and in FIG. 4G (and as shown and discussed in U.S. Pat. No. 11,662,084). In some embodiments, sub-assembly 300 may be attached to spackle-frame 201 as shown in FIG. 2A, FIG. 2B, FIG. 4G and in FIG. 4H (and as shown and discussed in U.S. Pat. No. 11,662,084). In some embodiments, mechanical-fastener(s) 207 may be used to attached main-disc 101 (of downsizer-ring 100) to a bottom of given ceiling 406, as shown in FIG. 4D and in FIG. 4E. In some embodiments, at least a portion of a given mechanical-fastener 207 may fit into and/or pass through a given hole-for-fastener 119 of main-disc 101. In some embodiments, assembly 200 may comprise at least one mechanical-fastener 207. In some embodiments, assembly 200 may comprise one or more mechanical-fasteners 207. In some embodiments, assembly 200 may comprise a plurality of mechanical-fasteners 207. See e.g., FIG. 2A and FIG. 2B.

Continuing discussing FIG. 2A and FIG. 2B, in some embodiments, spackle-frame 201 may comprise at least one aperture 209. In some embodiments, spackle-frame 201 may comprise one or more apertures 209. In some embodiments, spackle-frame 201 may comprise a plurality of apertures 209. In some embodiments, aperture(s) 209 may be “aperture(s) 203” U.S. Pat. No. 11,662,084. In some embodiments, a given aperture 209 may be configured to receive at least a portion of a mechanical-fastener 404 therein (e.g., as shown in FIG. 4B). In some embodiments, at least one aperture 209 (of spackle-frame 201) may be aligned with at least one slot 139 (of raised-platform 103), for a purpose of having a given mechanical-fastener 404 pass at least partially through both that given aperture 209 and that given slot 139 (or hole 141) that are aligned with each other. For example, and without limiting the scope of the present invention, FIG. 2A shows at least some apertures 209 being (vertically) aligned with at least some slots 139 (such that their void spaces are in vertical alignment with each other for receiving a therethrough mechanical-fastener 404). In some embodiments, “alignment” between holes and/or slots of one part with another part may be for a purpose of fitting a given mechanical fastener (at least partially) through such aligned holes and/or slots.

Continuing discussing FIG. 2A and FIG. 2B, in some embodiments, spackle-frame 201 may comprise outside-diameter 211. In some embodiments, outside-diameter 211 may be an outside (largest) diameter of the flat, planar, annular, disc, and/or flange structure/geometry of spackle-frame 201. In some embodiments, outside-diameter 211 may be predetermined, uniform, fixed, finite, and/or non-variable. In some embodiments, outside-diameter 211 may be smaller than diameter-of-interior-volume 151 of interior-volume 147 (of main-disc 101).

FIG. 2A shows how an upward-extending-collar 213 of spackle-frame 201 may pass through (within) inside-edge 133 and/or inside-diameter 135 of raised-platform 103 and/or of downsizer-ring 100. In some embodiments, spackle-frame 201 may comprise upward-extending-collar 213. In some embodiments, upward-extending-collar 213 may be a hollow right cylindrical member, i.e., a collar (sleeve), the extends upwards from the flat annular disc and/or flange portion of spackle-frame 201. In some embodiments, upward-extending-collar 213 may have a height. In some embodiments, for a given spackle-frame 201, the height of upward-extending-collar 213 may be predetermined, uniform, fixed, finite, and non-variable. In some embodiments, upward-extending-collar 213 may have an outside diameter that is less than inside-diameter 135. In some embodiments, for a given spackle-frame 201, the outside diameter of upward-extending-collar 213 may be predetermined, uniform, fixed, finite, and non-variable. A diameter of upward-extending-collar 213 may be diameter 214 which is first explicitly called out in FIG. 4E.

Continuing discussing FIG. 2A, in some embodiments, clips 215 of flangeless-trim-subassembly 203 (at a bottom [lower] portion of flangeless-trim-subassembly 203) may be configured to clip onto a top of upward-extending-collar 213, for connecting flangeless-trim-subassembly 203 to spackle-frame 201. In some embodiments, flangeless-trim-subassembly 203, around a periphery of its bottom (lower) portion (but not all the way at the bottom), may comprise clips 215. In some embodiments, clips 215 may be configured to clip (snap) onto the top of upward-extending-collar 213 (of spackle-frame 201).

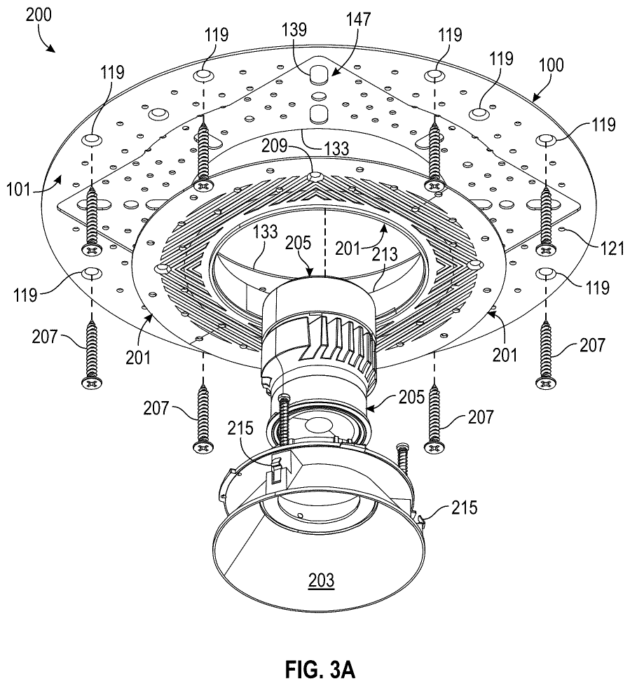

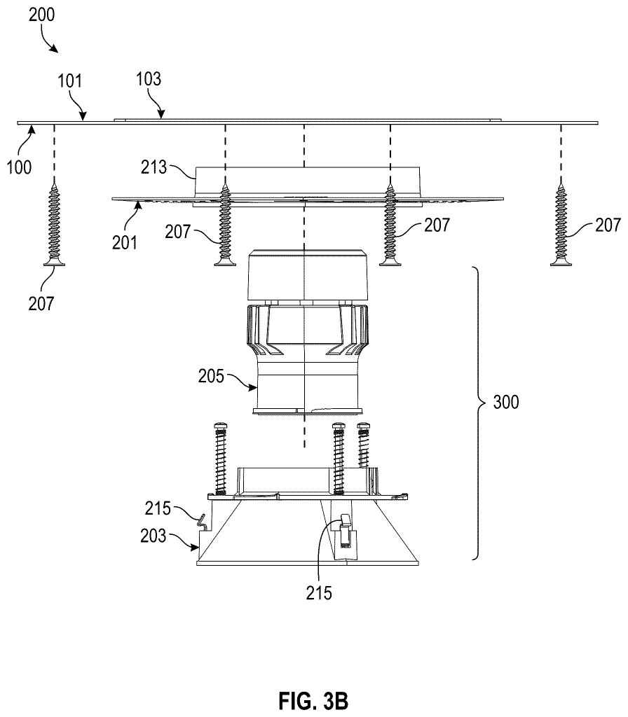

FIG. 3A and FIG. 3B are exploded views of assembly 200. FIG. 3A is a bottom perspective exploded view of assembly 200. FIG. 3B is a side view (or front view or rear view) exploded view of assembly 200. FIG. 3A shows how mechanical-fastener(s) 207 may be fitted (inserted), at least partially, into (at least some) hole-for-fastener 119 of main-disc 101 of downsizer-ring 100, wherein such mechanical-fastener(s) 207 may be used to attached downsizer-ring 100 to a given ceiling 406. Note, ceiling 406 is omitted in FIG. 3A, but is shown in FIG. 4C. FIG. 3A shows how the flat, annular, disc, and/or flange portion of spackle-frame 201 may be inserted into interior-volume 147 of main-disc 101 and/or of downsizer-ring 100, wherein the upward-extending-collar 213 portion of spackle-frame 201 may pass through inside-edge 133 and/or inside-diameter 135 of raised-platform 103 and/or of downsizer-ring 100. FIG. 3A shows how top and/or upper regions (portions) of light-module 205 may be inserted into and through inside-edge 133 and/or inside-diameter 135 of raised-platform 103 and/or of downsizer-ring 100. FIG. 3A and FIG. 3B show how a bottom of light-module 205 may be (removably) attached to a top (upper) region (portion) of flangeless-trim-subassembly 203 (e.g., via a twisting interaction). FIG. 3B shows how flangeless-trim-subassembly 203 and light-module 205 together form subassembly 300 (e.g., when light-module 205 and flangeless-trim-subassembly 203 are attached to each other). In some embodiments, subassembly 300 may comprise one (1) flangeless-trim-subassembly 203 and one (1) light-module 205 that are (removably) attached to each other. In some embodiments, the bottom (twist-lock flange) of light-module 205 may be (removably) attached to a top (upper) region (portion) of flangeless-trim-subassembly 203 (e.g., via a twisting interaction) to form subassembly 300.

Note, FIG. 4A through FIG. 4H shows at least some steps for using downsizer-ring 100, assembly 200, spackle-frame 201, flangeless-trim-subassembly 203, light-module 205, subassembly 300, and/or ceiling 406. In some embodiments, FIG. 4A to FIG. 4H may collectively form a method of using downsizer-ring 100, assembly 200, spackle-frame 201, flangeless-trim-subassembly 203, light-module 205, subassembly 300, and/or ceiling 406 together.

FIG. 4A is a bottom perspective view of a step 401, showing an initial process of attaching a given spackle-frame 201 to a given downsizer-ring 100. In some embodiments, in FIG. 4A arrow 402 may be indicating that the round, annular, disc, planar, and/or flange portion of spackle-frame 201 may be inserted into interior-volume 147 of a bottom 111 of downsizer-ring 100 and that the upward-extending-collar 213 of spackle-frame 201 may be inserted up and into (through) inside-edge 133 and/or inside-diameter 135 of downsizer-ring 100 in this step 401.

FIG. 4B is a bottom perspective view of a step 403 of attaching (securing) spackle-frame 201 to interior-volume 147 of downsizer-ring 100 using at least one (one or more) mechanical-fastener(s) 404. In some embodiments, a given mechanical-fastener 404 may be selected from: a screw, a bolt, a nail, a brad, a rivet, a pin, a dowel, a portion thereof, combinations thereof, and/or the like. In some embodiments, in step 403, at least some of the apertures 209 (of spackle-frame 201) may be vertically aligned with at least some of the slots 139 (or holes 141) of downsizer-ring 100 (e.g., so that a given mechanical-fastener 404 may pass through aligned openings of both). In some embodiments, in step 403, at least a portion of a given mechanical-fastener 404 may pass through an aperture 209 (of spackle-frame 201) and into a slot 139 (or hole 141) of downsizer-ring 100. In some embodiments, step 403 may proceed after step 401. In some embodiments, mechanical-fastener(s) 404 may be of a flat head type (form factor). In some embodiments, once a given mechanical-fastener 404 may be passing through a pair of aligned aperture 209 and slot 139 (or hole 141), a portion of that mechanical-fastener 404 that protrudes from a top of raised-platform 103 may be further secured by attaching a nut to that top protruding portion of mechanical-fastener 404 to further secure the spackle-frame 201 to the downsizer-ring 100.

FIG. 4C is a bottom perspective view showing how a given downsizer-ring 100 (with or without an attached spackle-frame 201) may be attached to a bottom portion (region or section) of a given ceiling 406. FIG. 4C also shows a step 405 of fitting a given downsizer-ring 100 (with or without an attached spackle-frame 201) to a bottom portion (region or section) of the given ceiling 406, such that downsizer-ring 100 at least partially covers over a hole 407 in that portion of ceiling 406. Note, hole 417 (of ceiling 406) may be a through hole that passes entirely through a thickness of ceiling 406. Hole 417 may comprise a diameter 418. Note, diameter 418 (of ceiling 406 hole 417) may be larger than outside-diameter 211 of spackle-frame 201, which is why downsizer-ring 100 must be used as an intermediary (bridge) to permit (enable) that spackle-frame 201 to be used with that otherwise too large ceiling 406 hole 417. In some embodiments, outside-diameter 105 (of main-disc 101 of downsizer-ring 100) may be larger than diameter 418 of hole 417. Arrow 419 in FIG. 4C may indicate that downsizer-ring 100 (with or without an attached spackle-frame 201) may be fitted to ceiling 406 hole 417, such that, inside-edge 133, inside-diameter 135, and/or upward-extending-collar 213 (if present) may be within hole 417. In some embodiments, in executing step 405, an installer may center downsizer-ring 100 with an opening of hole 417 in ceiling 406 and make sure there is sufficient ceiling 406 material on all sides of the hole 417 to accommodate portions of main-disc 101 covering over at least some of that ceiling 406 material around hole 417 and for there to be room in that ceiling 406 material to receive mechanical-fastener(s) 207 therein. In some embodiments, prior to an installer (person) executing step 405, the installer may clear and/or clean a bottom surface of ceiling 406 in an area proximately around hole 417, e.g., to smooth out any rough edges/surfaces of ceiling 406 proximate to hole 417 (wherein proximate in this context may be half of outside-diameter 105 from a nearest edge of hole 417); because downsizer-ring 100 may work better when installed against a ceiling 406 that is at least substantially (mostly) smooth and/or flat.

FIG. 4D is a bottom perspective view showing a given downsizer-ring 100 (with or without an attached spackle-frame 201) has been fitted to the bottom portion (region or section) of the given ceiling 406 and is ready to receiving mechanical-fastener(s) 207 to attach (secure) that downsizer-ring 100 to that bottom portion of ceiling 406. FIG. 4D also shows a step 407 of attaching (securing) the given downsizer-ring 100 (with or without an attached spackle-frame 201) to the bottom portion (region or section) of the given ceiling 406 using mechanical-fastener(s) 207. In some embodiments, in step 407 at least a portion of given mechanical-fastener 207 may pass through a given aperture 119 of downsizer-ring 100 and into portion of ceiling 406. In some embodiments, in step 407 all or less than all apertures 119 (of downsizer-ring 100) may receive mechanical-fasteners 207 therein. In some embodiments, at least one mechanical-fastener 207 may partially pass (drive) into a joist (or the like) above ceiling 406; and/or into a drywall anchor embedded within ceiling 406 and aligned with at least one aperture 119 (of downsizer-ring 100). Note, diameter 418 (of ceiling 406 hole 417) may not reach (not extend to) aperture(s) 119 (of downsizer-ring 100). In some embodiments, in executing step 407 the installer may hold flush against a bottom surface of ceiling 406 (centered around hole 417) and screw (or the like) downsizer-ring 100 into place using mechanical-fastener(s) 207. In some embodiments, mechanical-fastener(s) 207 may be No. 8and/or No. 10 drywall screws; and of a maximum length of ¾ of an inch for mechanical-fastener(s) 207 in some embodiments).

FIG. 4E is a bottom perspective view showing plaster 421 being applied by a tool 423 to bottom surfaces of downsizer-ring 100, spackle-frame 201, and ceiling 406 for generating a flangeless trim recessed light fixture installation. In some embodiments, FIG. 4E may show a step 409 of applying plaster 421 by use of tool 423 to bottom surfaces of downsizer-ring 100, spackle-frame 201, and ceiling 406 for generating a flangeless trim recessed light fixture installation. In some embodiments, once step 409 may be complete (and the plaster 421 dried [and optionally painted]), bottom exterior surfaces of downsizer-ring 100, spackle-frame 201, and ceiling 406 (in proximity to the plastered over regions) may all look substantially (essentially) the same from a perspective of a human observer located beneath that region of ceiling 406 (e.g., as shown in FIG. 4G and in FIG. 4H). In some embodiments, plaster 421 may also be referred to as mud and/or as spackle and may be used to cover over an exterior surface of drywall. In some embodiments, tool 423 may be a putty knife and/or the like. FIG. 4E may also show a region (volume) of void-space 425 that may be empty (aside from air) in FIG. 4E and during execution of step 409. In some embodiments, void-space 425 may be empty space (aside from air) within diameter 214 (of upward-extending-collar 213) and/or upward-extending-collar 213 (of spackle-frame 201) and/or immediately above ceiling 406 at diameter 214 and/or upward-extending-collar 213 (of spackle-frame 201). In some embodiments, step 409 may follow execution of step 407 (if step 403 has already been completed). In some embodiments, both step 403 and step 407 must be completed before executing step 409; however, it is possible to complete step 407 before completing step 403.

FIG. 4F is a bottom perspective view showing a step 411 of connecting a given flangeless-trim-subassembly 203 to a given light-fixture 205. In some embodiments, step 411 may be a step of forming subassembly 300 by connecting a given flangeless-trim-subassembly 203 to a given light-fixture 205. In some embodiments, light-fixture 205 may be connected to flangeless-trim-subassembly 203, by inserting a bottom flange of light-fixture 205 into a top opening of flangeless-trim-subassembly 203 and twisting (rotating) light-fixture 205 with respect to flangeless-trim-subassembly 203. FIG. 4F may also portions of two adjoining vertical walls 427 below ceiling 406 (merely for providing some possible context to FIG. 4F). In some embodiments, step 411 may follow execution of step 409. In some embodiments, step 411 may be executed prior to executing step 409.

FIG. 4G is a bottom perspective view showing a step 413 of making an electrical connecting between light-fixture 205 wiring and an electrical connector/wiring from the building. In some embodiments, the electrical wiring and/or connector from the building (and/or above ceiling located housing) may be located within and/or above void-space 425. FIG. 4G may also show plastered-ceiling 429, wherein beneath plastered-ceiling 429 may be installed downsizer-ring 100 and spackle-frame 201, but now entirely covered over by plaster 421. Plastered-ceiling 429 may be the result of completed step 409 (of FIG. 4E). In some embodiments, step 413 may follow execution of step 411; or step 413 may proceed step 411; or step 411 and 413 may be executed at least partially concurrently. In some embodiments, step 413 may (directly or indirectly) follow execution of step 409.

FIG. 4H is a bottom perspective view showing a step 415 of pushing and/or inserting subassembly 300 at least partially into and/or above void-space 425. In some embodiments, in step 415, subassembly 300 may be pushed upwards into void-space 425 until clips 215 engage the top edge/surface of upward-extending-collar 213 (of spackle-frame 201). In FIG. 4H upward pointing arrow 431 may indicate a direction of pushing/inserting subassembly 300 upwards into void-space 425. In some embodiments, once the clips 215 engage the top edge/surface of upward-extending-collar 213 (of spackle-frame 201), then an opening edge to the reflector (of flangeless-trim-subassembly 203) may be at least substantially (mostly) flush the bottom (plastered) surface of spackle-frame 201. In some embodiments, step 415 may follow execution of step 413.

In some embodiments, downsizer-ring 100 (downsizer-adapter 100) may comprise main-disc 101 (largest-disc 101) and raised-platform 103. In some embodiments, main-disc 101 and raised-platform 103 are attached to each other. In some embodiments, main-disc 101 and raised-platform 103 are integrally attached to each other such that main-disc 101 and the raised-platform 103 are a single article of manufacture. See e.g., FIG. 1A to FIG. 1G for downsizer-ring 100, main-disc 101, and raised-platform 103.

With respect to main-disc 101 and in general reference to FIG. 1A to FIG. 1G, in some embodiments, main-disc 101 may be in at least substantially (mostly) right-cylinder shape where an outside-diameter 105 of the main-disc 101 is larger than height 113 of the main-disc 101. In some embodiments, the main-disc 101 may comprise an interior-volume 147 that is hollow (e.g., when not at least partially filled with a portion of spackle-frame 201). In some embodiments, the interior-volume 147 may be configured to receive an annular-disc portion of spackle-frame 201 within the interior-volume 147 such that when the annular-disc portion (of spackle-frame 201) is within the interior-volume 147 a bottom-surface 111 of main-disc 101 and a bottom surface of the annular-disc portion (of spackle-frame 201) may be at least substantially (flush) flush with each other (e.g., occupying a same plane with each other) (see e.g., FIG. 2B and FIG. 4B). In some embodiments, main-disc 101 may comprises a plurality of holes-for-fasteners 119 that are through holes in main-disc 101 that are configured to receive mechanical-fasteners 207 therein for attaching the downsizer-ring 100 to ceiling 406 (see e.g., FIG. 2A, FIG. 2B, FIG. 4D, and FIG. 4E). In some embodiments, hole(s) 119 extend from bottom-surface 111 to top-surface 109 (in a linearly straight fashion) passing entirely through a thickness/height 113 of main-disc 101. In some embodiments, a hole-for-fastener 119 selected from the plurality of holes-for-fasteners 119 may be beveled around an opening to that hole-for-fastener 119 on the bottom-surface 111 of main-disc 101 such that the bottom-surface 111 of main-disc 101 may be at least substantially (mostly) flush with a surface of a head of a mechanical-fastener 207 selected from the mechanical-fasteners 207 when that mechanical-fastener 207 may be (fully) inserted into that hole-for-fastener 119 (see e.g., FIG. 1D, FIG. 2B, FIG. 4D, and FIG. 4E). In some embodiments, main-disc 101 may comprises a plurality of holes 121 that may be through-holes in main-disc 101 and that are configured to receive plaster 421 therein (during installation of downsizer-ring 100 to ceiling 406 as shown in FIG. 4E). In some embodiments, hole(s) 121 extend from bottom-surface 111 and into material of main-disc 101. In some embodiments, main-disc 101 may comprise a plurality of holes-for-fasteners 119. In some embodiments, each hole 121 selected from the plurality of holes 121 may be smaller than a hole-for-fastener 119 selected from the plurality of holes-for-fasteners 119. In some embodiments, the interior-volume 147 may be inset into main-disc 101 from the bottom-surface 111 (and not from top-surface 109) of main-disc 101 by a uniform and fixed depth 153 that is less than the height 113 of main-disc 101. In some embodiments, depth 153 may be uniform, fixed, finite, predetermined, and/or non-variable height of interior-volume 147. In some embodiments, the inset-ness of interior-volume 147 into main-disc 101 from a bottom 111 of main-disc 101 may not extend into raised-platform 103. In some embodiments, a bottom 131 of raised-platform 103 may form a roof (ceiling) of interior-volume 147. In some embodiments, the interior-volume 147 may be at least one of: (entirely) open at a bottom of the inventor-volume 147 (e.g., for receiving of the annular-disc portion of spackle-frame 201 therein); mostly enclosed (closed) at a top of the interior-volume by bottom-surface 131 of raised-platform 103, aside from hole 133, holes 141/143 or slots 139 in raised-platform 103; and/or entirely (fully) enclosed around a (side) periphery of the interior-volume 147 by an interior-edge 145 of main-disc 101. In some embodiments, bottom-surface 131 of raised-platform 103 forms the top (ceiling/roof) of interior-volume 147. In some embodiments, the interior-edge 145 may be disposed between the top of the interior-volume 147 and the bottom of the interior-volume 147. In some embodiments, from a bottom view of the downsizer-ring 100, the interior-volume 147 has a modified-square shape wherein that modified-square shape is square shaped but with two modifications, namely: one, that the four (4) corners of the modified-square shape are rounded; and two, that each side of that modified-square shape has an outwards curving region 117 that curves towards outside-edge 107 of main-disc 101 (i.e., there are four (4) such separate and distinct outwards curving region 117 of this modified-square shape of interior-volume 147 [one per side of this modified-square shape]). In some embodiments, a given outwards curving region 117 may be located in a middle of each side of the modified-square shape of interior-volume 147. See e.g., FIG. 1A to FIG. 1G for main-disc 101.

With respect to raised-platform 103 and in general reference to FIG. 1A to FIG. 1G, in some embodiments, raised-platform 103 extends above top-surface 109 of main-disc 101. In some embodiments, from a top view of the downsizer-ring 100, an outer periphery of raised-platform 103 has a square shape with rounded corners. In some embodiments, width 127 of the square shape of raised-platform 103 is less than the outside-diameter 105 of main-disc 101. In some embodiments, width 127 of the square shape of raised-platform 103 is less than width 149 of the interior-volume 147 of main-disc 101. In some embodiments, raised-platform 103 extends above the top-surface 109 of main-disc 101 by height 125 of raised-platform 103, wherein height 125 may be is uniform and fixed. In some embodiments, a dimension of height 125 (of raised-platform 103) and a dimension of height 113 (of main-disc 101) may be the same or substantially the same. In some embodiments, raised-platform 103 may comprise a plurality of slots 139 that are configured for receiving mechanical-fasteners 404 therein for securing raised-platform 103 to the spackle-frame 201 (see e.g., FIG. 4A and FIG. 4B). In some embodiments, raised-platform 103 may comprise a plurality of holes-for-fasteners 141 that are configured for receiving mechanical-fasteners 404 therein for securing raised-platform 103 to the spackle-frame 201. In some embodiments, raised-platform 103 may comprise a plurality of holes 143 that are through-holes in raised-platform 103 and that are configured to receive plaster 421 therein (see e.g., FIG. 4E). In some embodiments, hole(s) 143 extend from bottom-surface 131 and into material of raised-platform 103. In some embodiments, raised-platform 103 comprises a largest-hole 133 that is a through-hole in raised-platform 103 that is configured to receive an upward-extending-collar 213 of the spackle-frame 213 therein (see e.g., FIG. 2A). In some embodiments, this largest and/or main hole 133 of raised-platform 103 (and of downsizer-ring 100) may be located in a center of raised-platform 103, with respect to a top view and/or a bottom view of raised-platform 103 (e.g., centered about center 137). In some embodiments, the largest and/or main hole 133 of raised-platform 103 (and of downsizer-ring 100) may extend from bottom-surface 131 to top-surface 123 all the way through material (height/thickness 125) of raised-platform 103. See e.g., FIG. 1A to FIG. 1G for raised-platform 103.

In some embodiments, a system and/or a kit may comprise downsizer-ring 100 and at least one of: spackle-frame 201, flangeless-trim 203, and/or light-module 205.

In some embodiments, downsizer-ring 100 and/or a portion thereof may be rigid and/or stiff. In some embodiments, downsizer-ring 100 and/or a portion thereof may not be flexible.

In some embodiments, downsizer-ring 100 and/or a portion thereof may be made from at least one of the following materials: a metal, an alloy, a plastic, a wood, a resin, carbon fiber, a ceramic, a portion thereof, a laminate thereof, combinations thereof, and/or the like.

An adapter referred to herein as a downsizer-ring, along with system(s) and/or kit(s) of including such downsizer-rings have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A downsizer ring comprising:
a main-disc that is in a right-cylinder shape where an outside-diameter of the main-disc is larger than a height of the main-disc; wherein the main-disc comprises an interior-volume that is hollow, wherein the interior-volume is configured to receive an annular-disc portion of a spackle-frame within the interior-volume such that when the annular-disc portion is within the interior-volume a bottom-surface of the main-disc and a bottom surface of the annular-disc portion are at least substantially flush with each other; and
a raised-platform that extends above a top-surface of the main-disc;
wherein the main-disc and the raised-platform are attached to each other.

2. The downsizer-ring according to claim 1, wherein the main-disc comprises a plurality of holes-for-fasteners that are through holes in the main-disc that are configured to receive mechanical-fasteners therein for attaching the downsizer-ring to a ceiling.

3. The downsizer-ring according to claim 2, wherein a hole-for-fastener selected from the plurality of holes-for-fasteners is beveled around an opening to that hole-for-fastener on the bottom-surface of the main-disc such that the bottom-surface of the main-disc is at least substantially flush with a surface of a head of a mechanical-fastener selected from the mechanical-fasteners when that mechanical-fastener is inserted into that hole-for-fastener.

4. The downsizer-ring according to claim 1, wherein the main-disc comprises a plurality of holes that are through-holes in the main-disc that are configured to receive plaster therein.

5. The downsizer-ring according to claim 4, wherein the main-disc comprises a plurality of holes-for-fasteners; wherein each hole selected from the plurality of holes is smaller than a hole-for-fastener selected from the plurality of holes-for-fasteners.

6. The downsizer-ring according to claim 1, wherein the interior-volume is inset into the main-disc from the bottom-surface of the main-disc by a uniform and fixed depth that is less than the height of the main-disc.

7. The downsizer-ring according to claim 1, wherein the interior-volume is: open at a bottom of the inventor-volume; mostly enclosed at a top of the interior-volume by a bottom-surface of the raised-platform, aside from holes or slots in the raised-platform; and entirely enclosed around a periphery of the interior-volume by an interior-edge of the main-disc; wherein the interior-edge is disposed between the top of the interior-volume and the bottom of the interior-volume.

8. The downsizer-ring according to claim 1, wherein from a bottom view of the downsizer-ring, the interior-volume has a modified-square shape wherein the modified-square shape is square shaped but with two modifications, namely: that corners of the modified-square shape are rounded; and that each side of the modified-square shape has an outwards curving region that curves towards an outside-edge of the main-disc.

9. The downsizer-ring according to claim 8, wherein the outwards curving region is located in a middle of each side of the modified-square shape.

10. The downsizer-ring according to claim 1, wherein from a top view of the downsizer-ring, an outer periphery of the raised-platform has a square shape with rounded corners.

11. The downsizer-ring according to claim 10, wherein a width of the square shape of the raised-platform is less than the outside-diameter of the main-disc.

12. The downsizer-ring according to claim 10, wherein a width of the square shape of the raised-platform is less than a width of the interior-volume of the main-disc.

13. The downsizer-ring according to claim 1, wherein the raised-platform extends above the top-surface of the main-disc by a height of the raised-platform that is uniform and fixed.

14. The downsizer-ring according to claim 1, wherein the raised-platform comprises a plurality of slots that are configured for receiving mechanical-fasteners therein for securing the raised-platform to the spackle-frame.

15. The downsizer-ring according to claim 1, wherein the raised-platform comprises a plurality of holes-for-fasteners that are configured for receiving mechanical-fasteners therein for securing the raised-platform to the spackle-frame.

16. The downsizer-ring according to claim 1, wherein the raised-platform comprises a plurality of holes that are through-holes in the raised-platform that are configured to receive plaster therein.

17. The downsizer-ring according to claim 1, wherein the raised-platform comprises a largest-hole that is a through-hole in the raised-platform that is configured to receive an upward-extending-collar of the spackle-frame therein.

18. The downsizer-ring according to claim 1, wherein the main-disc and the raised-platform are integrally attached to each other such that the main-disc and the raised-platform are a single article of manufacture.
